(19) United States
(12) Patent Application Publication
(10) Pub. No.: US 2012/0281083 A1
(43) Pub. Date: Nov. 8, 2012

(54) Thermal Imager with Hermetically Sealed and Pressurized Housing

(76) Inventors: Brian Chivers, Dorset (GB); Andrew Christopher Chandler, Dorset (GB); Thomas James Parsons, Dorset (GB)

(21) Appl. No.: 13/510,119

(22) PCT Filed: Nov. 15, 2010
(86) PCT No.: PCT/GB2010/002103

§ 371 Date: Jul. 23, 2012

(30) Foreign Application Priority Data
Nov. 16, 2009 (GB) 0920036.1

(51) Int. Cl. H04N 5/33; H04N 7/18

(52) U.S. Cl. 348/81; 348/164; 348/143; 348/82; 348/148; 348/E05.09; 348/E07.085

(57) ABSTRACT

The present invention relates to an imaging device with a thermal imaging surveillance capability for safety, security and situational awareness. Closed circuit television systems (CCTV) are usually supported on drive and actuating mechanisms so that their active imaging portions are housed in a protective environment in a transparent dome. Existing thermal imaging devices are used in fixed configurations or on platforms and are bulky and expensive. In addition they are unsuitable for harsh marine environments. The invention is an imaging device and comprises: a thermal imager, which in use is housed within a sealed housing. A pan and tilt mechanism is supported in the housing for displacing the thermal imager. A dome, formed from an infra-red (IR) transmitting material, covers and seals the housing (which is ideally filled with an inert gas) thereby resulting in an arrangement that is resistant to exposure to water and salt and so provides an imager suitable for marine environments, as well resulting in an overall reduction in size of the imager compared with exposed pan and tilt mechanisms.

### BACKGROUND

The present invention relates to an imaging device, a related system and method of fabrication. More particularly, but not exclusively, the invention relates to an imaging device with a thermal imaging surveillance capability.

### PRIOR ART

Closed circuit television systems (CCTV) are usually supported on drive and actuating mechanisms so that their active imaging portions are housed in a protective environment. Conventionally CCTV cameras are housed within a transparent dome. The purpose of the dome is usually twofold in nature. Firstly, domes are tinted (so as to conceal the direction of the imager and to reduce glare); secondly the dome provides an environment which is sealed and protects lenses, actuators and drive equipment, from dirt, debris and moisture.

Existing thermal imaging devices are used in fixed configurations or on platforms. The platforms are sometimes driveable by an actuating mechanism, so that the line of sight (LOS) of the imager can be varied and selected by way of controllable pan and tilt drivers, however it has been difficult to house such systems within a dome. This is because thermal imagers have typically fallen into two main classes of the infrared region of the electromagnetic spectrum: the first class operates in the waveband around 3-5 μm.

The second class of thermal imagers operate in the 7-14 μm waveband, do not require cooling but are limited in that they are bulky, expensive and require specialised lenses.

Previously, operation of thermal imagers in both these wavebands requires expensive ancillary cooling, such as Stirling coolers, in order to maintain active thermal imaging sensors at requisite low temperatures so as to ensure optimal operation conditions. Not only are such coolers complex and expensive, they are also bulky, often requiring extensive cooling fins.

Recently however smaller thermal imagers have become available which do not require extensive cooling or driver software and these are incorporated into cameras and video devices. However, the materials which are transparent at these wavelengths tend to be extremely expensive and typically are formed from specialised sapphire/germanium glass and are usually only included in high specification military imagers.

Pan-tilt-zoom (PTZ) cameras are used in many applications and have tended to employ a day colour camera. However, in harsh environments, such as those that are encountered in marine situations, the problem of moisture ingress, and damage by salt becomes exacerbated.

In darkness, cameras operating in the visible spectrum can use a flashbulb on the camera. The combination of the camera and flashbulb is referred to as an active light system. A disadvantage of a flash bulb is that that objects faraway are not illuminated sufficiently to be imaged.

An Infra-red (IR) cameras can use active infra-red radiation sourced from a local IR source—an “active” light with the advantage being that the IR light is invisible to the human eye. The disadvantages of this type of “active” IR illumination is that objects beyond a few meters are insufficiently illuminated to be imaged and the “active” IR circuitry and bulbs are an added expense and complication.

Infra-red light emanates naturally from all objects and the wavelength of the light corresponds to the object temperature and emissivity. Until the advent of thermal imagers this latent IR light was hidden from the view of humans. A thermal imager can form an image from the latent IR light emanating from objects. Advantageously a thermal imager does not require any active IR lighting source. Another advantage is that a thermal camera can form images of objects several kilometres distant.

Patent KR 100671223 B1 describes an IR camera with an active IR light source to illuminate the scene. A pan and tilt mechanism points the camera in the desired direction. The camera with the pan and tilt mechanism is housed inside dome that is fixed to its support so that it cannot move. The dome made from a material is IR transparent and non IR reflecting.

Japanese Patent Application JP 2000305137 A describes an IR camera with an active IR light source to illuminate the scene. A pan and tilt mechanism points the camera in the desired direction. The camera with the pan and tilt mechanism is housed inside a dome that turns along with the camera as it is panned. The dome is made from an IR transparent material.

Published International Application WO-A1-2008/0178857 describes two IR cameras with two sets of IR light sources to illuminate the scene. A pan and tilt mechanism points the cameras in the desired direction. The camera with the pan and tilt mechanism is housed inside a dome that turns along with the camera as it is panned. The dome is made from an IR transparent material. A user employs a joystick to pan and tilt the camera.

A disadvantage of the devices described in KR 100671223 B1, JP 2000305137 A, and WO 2008/017857 A1 is that the housing that contains the camera and pan and tilt mechanism is not sealed against the outside elements. Thus condensation can occur on the inside surface of the IR window rendering the imaging capability decrepit. A further disadvantage is that these devices require the complication and expense of active IR lighting which is only capable of short range imaging.

Chinese Patent Application CN 101511005 A describes a thermal imaging device which does not require active IR lighting. A thermal imager and a visible spectrum imager are both fixed to the same pan and tilt mechanism. The imagers and pan and tilt mechanism are housed inside dome that is fixed to its support so that it cannot move. There are additional thermal imagers mounted outside the dome around the circumference so that an object can be tracked as it moves across the field of view of each one of these thermal imagers. The pan and tilt mechanism with the thermal and visible imager mounted on it automatically points at the tracked object. This device is capable of detecting and counting people in a room. A disadvantage of this device is that the housing is not sealed. Thus condensation can occur on the inside surface of the IR window rendering the imaging capability decrepit. Designed as a university project, the multiple IR imagers mounted around the circumference of the dome are impractically expensive method of tracking or stabilizing an image. Furthermore these IR imagers are mounted outside the dome and are prone to moisture and other external damage.

U.S. Pat. No. 5,729,016 A describes a thermal imaging device which does not require active IR lighting. The thermal imager is contained inside a sealed box. One face of the box is a nearly flat IR transparent window through which the thermal imager peers. The sealed box is mounted on a pan and tilt mechanism. A user employs a joystick to pan and tilt the box and thereby the thermal imager. The device is designed to be installed in a recessed aperture of a yacht, or on top of the roof of a police car, or on the exterior of a building. The fact that this device is mounted in a box with a nearly flat IR transparent window is a disadvantage because persons being observed through the thermal imager can see the motion of the box as it pans and tilts to follow them.

The present invention arose in order to overcome the aforementioned drawbacks associated with prior art imaging devices, which is particularly well suited for the marine environment to improve security during darkness.

### SUMMARY OF THE INVENTION

According to a first aspect of the invention there is provided an imaging device. It comprises: a thermal imager for forming an image of an object from IR radiation from the object, the imager being housed within a hermetically sealed housing, a pan and tilt mechanism for displacing the thermal imager; and a window, defined by at least a portion of dome. The window is formed from an infra-red (IR) transmitting material, the window in use is located intermediate the object and the thermal imager.

The advantage of the IR transmitting window is that the thermal imager can peer through it. Preferably the window is fixed to the housing. This prevents movement of the dome relative to the housing. Advantageously the seal between dome the housing is a hermetic seal. It will not become worn and it will not begin to leak because there is no relative motion to wear down the seal.

The advantage of a fixed hermetically sealed dome is the that the seal will never leak unlike a seal on a dome that rotates as the imager pans. Such a moving seal will become worn and gradually let fluid through.

The use of a static housing provides a single seal from aggressive marine environments and is a cost effective solution to sealing an exposed pan and tilt mechanism.

In one embodiment all moving parts are housed inside the hermetically sealed housing and behind the hermetically sealed dome. As a result of sealing the imager, actuator and control devices inside a hermetically sealed housing, ingress of salt and moisture is inhibited and this thereby ensures that delicate devices, integrated circuits and optical surfaces are not affected by aggressive salt conditions. The interior surface of the IR window remains clear and dry.

Preferably the thermal imager forms an image of objects from IR radiation emanating from the objects. The advantage is that no active source lighting is required.

Because all moving parts are housed behind the hermetically sealed dome, the subject being detected is able to be tracked without the subject being aware. It is relatively dark inside the sealed housing, and the dome may be opaque to visible light.

Ideally the infra-red (IR) transmitting material includes a portion in the form of a dome which is typically formed from an infra-red synthetic plastics material such as an infra red transparent polymer, such as poly-IR (Trade Mark). Ideally there is sufficient clearance provided between an inner surface of the dome and the thermal imager so that the imager is actuated by a pan mechanism, through an X-Z (horizontal) plane and by a tilt mechanism, through a Y-Z (vertical) plane. The azimuth movement is ideally 360° continuous and is activated by a motor and gear drive. The elevation is ideally between 0° and 90° and is likewise activated by a motor and gear. Each motor is controlled by a remote user for example via a joystick or other interface.

Preferably the dome is fitted to a cylindrical housing and is connected by way of an O-ring seal that hermetically seals the housing when the dome is connected thereto. The O-ring seals are advantageously formed from an O-ring nitrile material which are resistant to salt water and ensure that the internal volume of the cylindrical housing remains dry. The cylinder is formed from a material in the corrosion resistant group comprising stainless steel, aluminium or carbon fibre.

In a particularly preferred embodiment the imaging device includes a pan and tilt mechanism for enabling an operator to vary the field of regard (that is the total viewable field), from an external location as a result of a telemetric link.

The images formed by the imager are passed via a telemetric link to an external image display device. Possible image display devices include flat screen computer monitors, televisions, and mobile phones.

Ideally there is a motion stabiliser so that motion of a vessel, for example in heavy seas, can be compensated.

The effect of the motion stabiliser is to maintain steady images on the display screen even as the imaging device is tossed by the motion of the vessel. The motion stabiliser may comprise sensors, such as rate gyros or inclinometers included in the housing to stabilise the pan and tilt mechanism. Alternatively the motion stabiliser may be an electronic device that stabilises the image by processing a signal derived from the imager.

A motion stabilizer is distinguished from an image tracking mechanism. Both may appear to have the same effect—that of maintaining a formed image motionless. The motion stabilizer compensates for the motion of the object to which the imager is fixed. It does this by sensing the motion from a motion sensor, or calculating the motion from the way the entire image is moving. Then it may pan and tilt the imager to correct the direction the imager points, or it may electronically shift the image formed by the imager. By contrast a tracking mechanism selects an object to track and commands the pan and tilt mechanism to track it,

This invention may include a motion stabilizer. The motion stabiliser steadies the image formed on the screen even if it is fixed to a platform which rotates in its axis such as a yacht rolling and pitching on a rough sea. Advantageously because of the motion stabilizer an operator attempting to use a joystick to find objects with the imager does not find it any more difficult to do so for example in rough sea than in calm sea or on a moving tower or aircraft.

The invention may also comprise an automatic tracking mechanism. It may work in conjunction with a motion stabilizer or independently. Optionally the imaging device can include a zoom lens or an automatic focus control mechanism. The automatic focus control mechanism may be aided by a temperature dependent automatic focus controller.

Optionally within the sealed housing is a visible spectrum imager (a camera). Advantageously this type of camera can discern the colour of objects.

Optionally the imaging device comprises a means to monitor temperatures of objects imaged. Advantageously this enables objects of interest to be located automatically using threshold detection techniques, thereby permitting automatic scanning and location facilities to be employed in the imaging device. Such detection techniques can be performed under control of software that may also be configured to perform automatic scans of sea areas for example for landmarks, buoys, ships, lost or missing items or personnel.

The imaging device is preferably assembled by mounting components, actuators, support assemblies and control equipment in the cylindrical housing, by fitting and mounting components, devices and controllers to a back plate, passing power, control and signalling cable through a sealed aperture and fixing and sealing the infra-red transparent dome onto the housing, for ease of assembly.

In use the complete assembled system is fitted into ceilings or deck heads of marine vessels and craft. Once the system is secured in place, a polished ‘316 grade’ stainless steel fascia is ideally fixed via a quarter-turn mechanism to conceal fixings.

The system as described relates to a sealed, housing (conforming to British Standard IP68) that incorporates the use of an infrared-transmitting dome. The internal mechanism contains a thermal imaging sensor (also called a thermal imager) placed on a pan and tilt style platform. The pan and tilt function is remotely controlled by the user via a joystick or software interface.

In addition the invention results in an overall reduction in size of the imager compared with exposed pan and tilt mechanisms.

The invention shows an image and it is also in effect also a heat sensor. Therefore it has many uses.

A user (not shown) controls the imaging device to survey an area to detect thermal activity, for example for the marine environment and provides a security/safety capability, for example for monitoring activity on a deck that was previously prohibitively expensive for installation on yachts in areas where security surveillance is becoming needed.

The invention may be used to detect and/or recognise and/or identify any object, vegetable, mineral or animal within the following environments: aircraft, storage areas, car parks, medical facilities, vehicles or craft, yachts, helicopters, any structure or location to which personnel or animals or indeed objects with an infra red signature have access. As an optional addition a passive infra-red sensing facility can be included so as to monitor pixellated activity thereby providing an integrated intruder warning capability which may be switched into an automatic mode and linked to an alarm.

The invention may be used by search and rescue personnel to locate a relatively warm person in a relatively cold sea or lake.

The invention may be mounted on a fire fighting vehicle. Fire fighting personal may use it to locate a fire burning inside a building by observing the thermal images of the exterior walls to find where they are hot.

The invention may be located inside a shop or factory to monitor or count people and/or objects and/or devices.

It may be located on a post in a car park to observe cars and people in the vicinity.

Preferred embodiments of the invention will now be described with reference to the Figures in which:

### BRIEF DESCRIPTION OF FIGURES

FIG. 1 shows an overall perspective view of the imager;

FIG. 2 is a cross sectional view of the imager of FIG. 1; and

FIG. 3 is an overall general assembly drawing showing outer dimensions and mounting template.

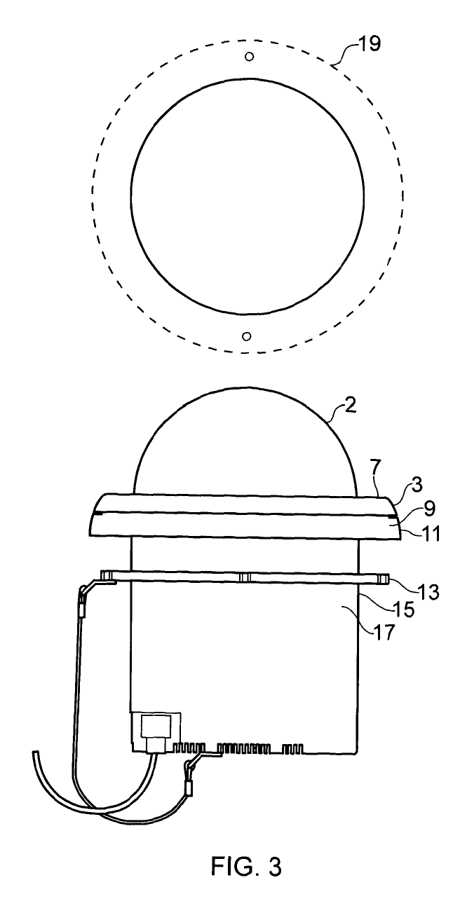

### DETAILED DESCRIPTION OF PREFERRED EMBODIMENTS OF THE INVENTION

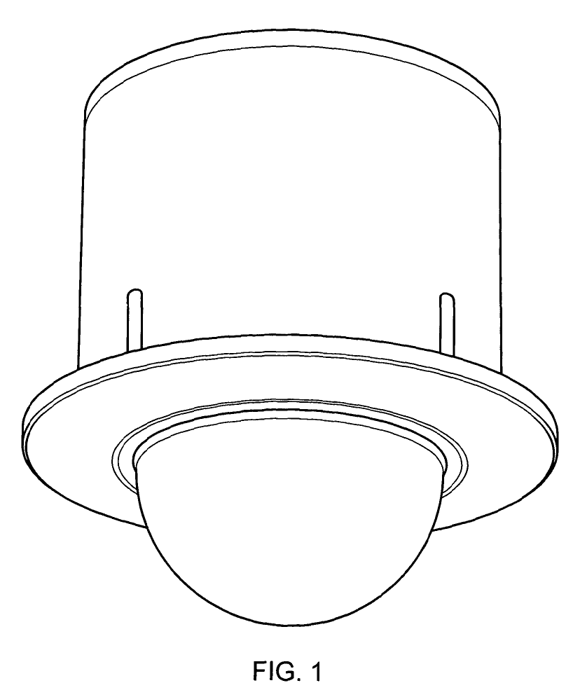

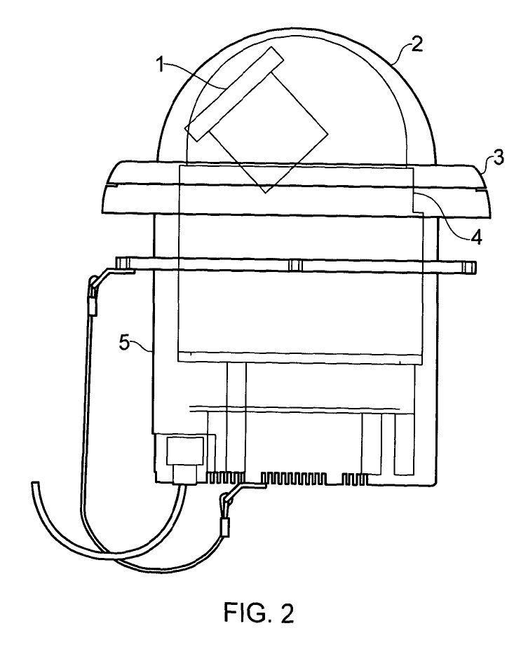

Referring to FIGS. 1 and 2, in which like parts bear the same reference numerals, generally there is shown a thermal imager 1, which is adapted for the marine environment, housed within a stainless steel housing 316 and behind an infra-red (IR) transmitting dome 2.

IR transmitting dome 2 encloses an hermetically sealed volume in which is housed the thermal imager 1 supported on a drivers, such a pan-tilt-zoom actuator (not shown).

The thermal imager 1 is supported on the pan-tilt-zoom actuator which itself is optionally supported on a gimbal (not shown) or another suitable stabilisation platform (not shown), operative under sensors (such as gyroscopes or solid state gyroscopes), so as to control the stability of the imager.

The imager, actuators, control devices, sensors and any stabilisation platforms are mounted on a base plate 7 that is connected to an interior of a generally right circular cylindrical shaped housing 5 formed from 316 stainless steel, which is a marine grade stainless steel stock tube with a machined finish.

The baseplate 7 is fitted to an inner portion of the housing 5 and contains all necessary fixing points for the internal structure via M3 stand-offs. A D38999 connector 8 is used as a sealed interface between sensing, control and drive devices as well as signal processing circuitry (not shown) that converts signals from the imager 1 to a form for transmission the internal electronics and the external cable.

Back plate is sealed via a double O-ring seal using British Standard sized nitrile O-rings. The back plate is fixed in place using M3 socket head countersunk screws.

The IR transparent dome 2 is sealed using a double O-ring seal. One O-ring seal is located either side of flange 20. The dome 2 is fixed in place using a brass retaining ring screwed into place, compressing the O-rings.

FIG. 2 shows how the thermal imager 1 is actuated by a pan mechanism, through a horizontal plane and by a tilt mechanism, through a Y-Z (vertical) plane. The locus of the extreme regions of the thermal imager 1 are shown in dotted line and so is as close to the interior surface of the dome 2 thereby providing an overall reduction in size of the imager compared with exposed pan and tilt mechanisms.

The azimuth (X-Z plane) movement is ideally 360° continuous and is activated by a motor and gear drive. The elevation is ideally between 0° and 90° and is likewise activated by a motor and gear. It is to be appreciated that these Figures are for illustration purposes only and other configurations are possible.

The imaging device is assembled in steps. At least one imager and a pan and tilt mechanism for displacing the, or each, imager, are enclosed in a housing. An O-ring seal is placed intermediate the housing and the dome comprising an infra-red (IR) transmitting material. The air in the enclosure is evacuated including all the moisture from the interior of the housing. An inert gas is introduced into the interior of the housing, then the enclosure comprising the housing and dome is hermetically sealed with the gas inside.

Preferably the inert gas is nitrogen. Preferably the pressure of the inert gas sealed inside the enclosure is slightly greater than atmospheric, about 1.0 atm to 1.1 atm.

The thermal imaging device may be fitted by forming an aperture in ceiling or deck heads of a vessel or craft or in the in a ceiling or wall or floor of a building, and inserting and fixing the imaging device in the aperture. Upon fitting the thermal imaging device to a vessel or craft it may be further secured with a polished fascia such a polished stainless steel onto an exposed flange of the housing.

The sealed housing of the thermal imaging device may be attached to the exterior fixture on a building, wall, or post.

A user (not shown) controls the imaging system to survey an area to detect thermal activity, for example for the marine environment and provides a security/safety capability, for example for monitoring activity on a deck that was previously prohibitively expensive for installation on yachts in areas where security surveillance is becoming needed.

It will be appreciated that the imager may be connected to video processing and recording equipment so that in use images and data may be recorded for subsequent transmission or storage. Such recording devices include, video cassette recorders (VCR), digital versatile disc (DVD), solid state storage facilities or hard drive devices, which may operate manually, automatically and optionally under control of software adapted to compress or analyse received images. As the technology for storing electronic image data is always evolving and the most appropriate technology may be used.

The invention has been described by way of several embodiments, with modifications and alternatives, but having read and understood this description further embodiments and modifications will be apparent to those skilled in the art.

All such embodiments and modifications are intended to fall within the scope of the present invention as defined in the accompanying claims.

Furthermore, it will be understood that although reference has been made to marine craft and vessels, the invention may be utilised in a myriad of other applications or systems.

1. An imaging device comprises: a thermal imager for forming an image of an object from IR radiation from the object, the imager being housed within a hermetically sealed housing, a pan and tilt mechanism for displacing the thermal imager; and a window, defined by at least a portion of dome, formed from an infra-red (IR) transmitting material, the window in sue is located intermediate the object and the thermal imager.

2. An imaging device according to claim 1 wherein the thermal imager forms an image of objects from IR radiation emanating from the objects.

3. An imaging device according to claim 1 wherein the portion of the dome is fixed to the housing preventing relative motion between them.

4. An imaging device according to claim 1 includes an automatic focus control mechanism.

5. An imaging device according to claim 1 includes a temperature dependent automatic focusing controller.

6. An imaging device according to claim 1 includes a zoom lens.

7. An imaging device according to claim 1 includes a visible spectrum imager.

8. An imaging device according to claim 1 includes an image display device.

9. An imaging device according to claim 1 comprising a motion stabilizing device to maintain steady images.

10. An imaging device according to claim 1 includes an image recording device.

11. An imaging device according to claim 1 includes an alarm triggered by a monitored pixelated image.

12. An imaging device as in claim 1 which comprises a hot regions sensor which detects fire.

13. An imaging device according to claim 1 includes a tracking device to control the pan and tilt mechanism for tracking objects.

14. An imaging device according to claim 1 wherein the pan and tilt mechanism and the imager are supported on a gimbal.

15. An imaging device, according to claim 1 includes a remote controller such as a joystick to control the pan and tilt mechanism via an external telemetric link.

16. An imaging device according to claim 1 wherein the dome is fitted to a cylindrical housing.

17. An imaging device as in claim 16 wherein an O-ring seals the connection between the housing and the dome.

18. An imaging device according to claim 17 wherein the O-ring seal is a nitrile seal.

19. An imaging device according to claim 16 wherein the cylindrical housing is formed from a material in the corrosion resistant group comprising: stainless steel, aluminum, and carbon fibre.

20. A method of assembling an imaging device according to claim 1 comprising the steps of: enclosing at least one imager in a sealed housing: placing an O-ring seal intermediate the housing and the dome comprising and infer-red (IR) transmitting material; evacuating air and moisture from the interior of the housing; and introducing an inert gas into the interior of the housing; and introducing an intert gas into the interior of the housing, then hermetically sealing the gas inside.

21. A method of assembling an imaging device according to claim 20 wherein the inert gas is nitrogen.

22. A method of fitting an imaging device according to claim 20 includes forming an aperture in ceiling or deck heads of a vessel or craft or in the ceiling or wall or floor of a building, and inserting and fixing the imaging device in the aperture.

23. A method of fitting an imaging device according to claim 20 includes attaching the sealed housing to an exterior fixture on a building, wall, or post.

24. A method of fitting an imaging device according to claim 22 and securing a polished stainless fascia onto an exposed flange of the housing.

25. A method of search and rescue using the imaging device of claim 1 to locate a relatively warm person in relatively cold water.

26. A method of fire fighting using the imaging device of claim 1 to locate the heat from burning.

27. A method of surveillance using the imaging device to claim 1 to monitor or count persons or animals.

28. A craft or vehicle fitted with the imaging device according to claim 1.
